(19) United States
(12) Patent Application Publication
(10) Pub. No.: US 2024/0098531 A1
(43) Pub. Date: Mar. 21, 2024

(54) METHODS, DEVICES AND COMPUTER STORAGE MEDIA FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/266,113

(22) PCT Filed: Dec. 10, 2020
(86) PCT No.: PCT/CN2020/135380

§ 371 Date: Jun. 8, 2023

(51) Int. Cl. H04W 24/08; H04L 5/00

(52) U.S. Cl. CPC H04W 24/08; H04L 5/005; H04L 5/0053

(57) ABSTRACT

Embodiments of the present disclosure relate to methods, devices and computer storage media for communication. A method comprises receiving, at a terminal device, at least one configuration about a first control resource set (CORESET) and a second CORESET, wherein the at least one configuration indicates that the first CORESET is associated with a first set of reference signals (RSs) for beam failure detection (BFD), and the second CORESET is associated with the first set of RSs or a second set of RSs for BFD; and monitoring at least one PDCCH candidate based on detection of a beam failure with assessing radio link quality over at least one of the first set of RSs and the second set of RSs. As such, some meaningless blind detection for PDCCH can be avoided, so as to increase the efficiency of PDCCH detection.

### TECHNICAL FIELD

Embodiments of the present disclosure generally relate to the field of telecommunication, and in particular, to methods, devices and computer storage media for communication.

### BACKGROUND

Recently, enhancements on the support for multi-Transmission and Reception Point (multi-TRP) deployment have been discussed. For example, it has been proposed to identify and specify features to improve reliability and robustness for physical channels (such as, Physical Downlink Control Channel (PDCCH), Physical Uplink Shared Channel (PUSCH) and/or Physical Uplink Control Channel (PUCCH)) other than Physical Downlink Shared Channel (PDSCH) using multi-TRP and/or multi-panel with Release 16 reliability features as a baseline. It has also been proposed to identify and specify features to enable inter-cell multi-TRP operations. It has also been proposed to evaluate and specify beam management related enhancements for simultaneous multi-TRP transmissions with multi-panel receptions.

In order to improve reliability and robustness for PDCCH, multiple schemes have been agreed to enable a PDCCH transmission with multiple transmission configuration indication (TCI) states (which correspond to different beams). Beam failure(s) may affect the reliability and robustness of PDCCH. Therefore, it is needed to consider the impact of beam failure(s) when implementing the above schemes.

### SUMMARY

In general, example embodiments of the present disclosure provide methods, devices and computer storage media for communication.

In a first aspect, there is provided a method of communication. The method comprises receiving, at a terminal device, at least one configuration about a first control resource set (CORESET) and a second CORESET, wherein the at least one configuration indicates that the first CORESET is associated with a first set of reference signals (RSs) for beam failure detection (BFD), and the second CORESET is associated with the first set of RSs or a second set of RSs for BFD; and monitoring at least one PDCCH candidate based on detection of a beam failure with assessing radio link quality over at least one of the first set of RSs and the second set of RSs.

In a second aspect, there is provided a method of communication. The method comprises receiving, at a terminal device, at least one configuration about a CORESET, wherein the at least one configuration indicates that: the CORESET is associated with a plurality of sets of reference signals (RSs) for beam failure detection (BFD); the CORESET is associated with a first transmission configuration indicator (TCI) state and a second TCI state; and a PDCCH candidate in a search space associated with the CORESET is associated with a first TI state and a second TCI state; and monitoring a PDCCH candidate based on detection of a beam failure with assessing radio link quality over at least one of the plurality of sets of RSs.

In a third aspect, there is provided a method of communication. The method comprises receiving, at a terminal device, at least one configuration about at least one control resource set (CORESET), wherein the at least one configuration indicates that the at least one CORESET is associated with at least one set of reference signals (RSs) for beam failure detection (BFD); and in response to a beam failure being detected with assessing radio link quality over at least one RS comprised in the at least one set of RSs, monitoring no PDCCH candidate in the at least one CORESET.

In a fourth aspect, there is provided a terminal device. The terminal device comprises a processor and a memory coupled to the processor. The memory stores instructions that when executed by the processor, cause the terminal device to perform the method according to the above first, second or third aspect of the present disclosure.

In a fifth aspect, there is provided a computer readable medium having instructions stored thereon. The instructions, when executed on at least one processor, cause the at least one processor to perform the method according to the above first, second or third aspect of the present disclosure.

In a sixth aspect, there is provided a computer program product that is stored on a computer readable medium and includes machine-executable instructions. The machine-executable instructions, when being executed, cause a machine to perform the method according to the above first, second or third aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates a flowchart of an example method in accordance with some embodiments of the present disclosure;

FIG. 3 illustrates a flowchart of an example method in accordance with some embodiments of the present disclosure;

FIG. 4 illustrates a flowchart of an example method in accordance with some embodiments of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As described above, in order to improve reliability and robustness for PDCCH, multiple schemes have been agreed. For example, in a non-single frequency network (non-SFN) scheme, to enable a PDCCH transmission with two transmission configuration indication (TCI) states (for example, which correspond to different beams), two search space (SS) sets associated with corresponding control resource sets (CORESETs) can be enabled for PDCCH repetitions. PDCCH candidates in the two CORRESETs can be linked together for transmitting repetitions of a same PDCCH. For another example, in a SFN scheme, one CORESET or one or more SS sets within one CORESET may be configured with two TCI states (for example, which correspond to different beams). That is, one PDCCH candidate in a given SS set is associated with both TCI states of the CORESET.

Beam failures may affect the reliability and robustness of PDCCH. Therefore, it is needed to consider the impact of beam failures when implementing the above schemes. However, regarding these schemes, the behavior of the terminal device in the event of partial beam failure (for example, some beams fail but other beams do not fail; or some beams or reference signals related to one TRP fail but other beams or reference signals related to another TRP do not fail) has not been specified yet.

Embodiments of the present disclosure provide a solution to solve the above problem and/or one or more of other potential problems. According to this solution, the behavior of the terminal device in the event of partial beam failure is specified under different schemes for PDCCH reliability enhancements. Moreover, some meaningless blind detection for PDCCH can be avoided, so as to increase the efficiency of PDCCH detection.

In the following, the terms “PDCCH monitoring occasion”, “PDCCH monitoring occasion”, “PDCCH transmission occasion”, “PDCCH transmission”, “PDCCH candidate”, “PDCCH reception occasion” and “PDCCH repetition” can be used interchangeably. The wording “monitor”, “detect”, and “decode” can be used interchangeably.

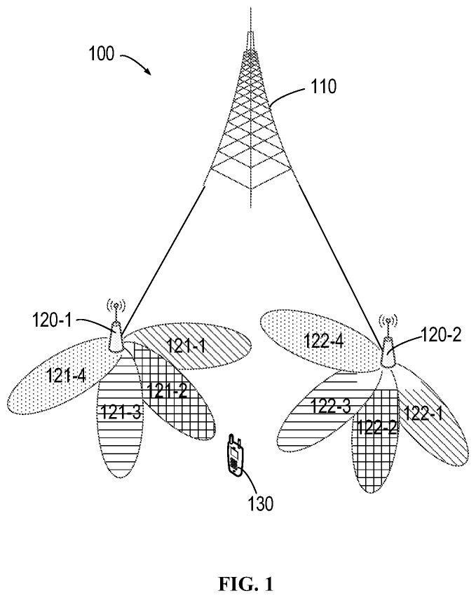

FIG. 1 illustrates an example communication network 100 in which embodiments of the present disclosure can be implemented. As shown in FIG. 1, the network 100 includes a network device 110, which is coupled with two TRPs/panels 120-1 and 120-2 (collectively referred to as TRPs 120 or individually referred to as TRP 120). The network 100 also includes a terminal device 130 served by the network device 110. It is to be understood that the number of network devices, terminal devices and TRPs as shown in FIG. 1 is only for the purpose of illustration without suggesting any limitations. The network 200 may include any suitable number of devices adapted for implementing embodiments of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 130.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like. The term “TRP” refers to an antenna array (with one or more antenna elements) available to the network device located at a specific geographical location. For example, a network device may be coupled with multiple TRPs in different geographical locations to achieve better coverage.

In one embodiment, the terminal device 130 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 130 from at least one of the first network device and the second network device. In one embodiment, first information may be transmitted to the terminal device 130 from the first network device and second information may be transmitted to the terminal device 130 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

As shown in FIG. 1, the network device 110 may communicate with the terminal device 130 via the TRPs 120-1 and 120-2. Each of the TRPs 120 may provide a plurality of beams for communication with the terminal device 130. For example, the TRP 120-1 may include four beams 121-1, 121-2, 121-3, and 121-4 (collectively referred to as “beams 121” or individually referred to as “beam 121”), while the TRP 120-2 may also include four beams 122-1, 122-2, 122-3 and 122-4 (collectively referred to as beams 122 or individually referred to as beam 122). It is to be understood that the number of beams as shown in FIG. 1 is only for the purpose of illustration without suggesting any limitations. The TRP 120 may provide any suitable number of beams adapted for implementing embodiments of the present disclosure.

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, a beam failure may occur if the network device 110 is no longer able to reach the terminal device 130 via at least one control channel (such as, PDCCH) or via at least one RS due to incorrect adjustment of the beams or some other reasons. For example, the terminal device 130 may detect this situation by estimating the quality of a hypothetical PDCCH reception transmitted over a beam (for example, a beam from the TRP 120-1 or 120-2) the network device 110 would use to reach the terminal device 130. To perform BFD, the terminal device 130 may estimate the quality of a hypothetical PDCCH reception based on Layer 1 Reference Signal Received Power (L1-RSRP) or Layer 1 Signal to Interference and Noise Ratio (L1-SINR) of a certain reference signal (RS). In the following text, this reference signal may also be referred to as “BFD RS” or “RS for BFD”. Examples of the BFD RS may include but not limited to periodic Channel State Information-Reference Signal (CSI-RS), synchronization signal block (SSB), or a combination thereof.

In NR, for each bandwidth part of a serving cell, the terminal device 130 may be configured with a set of BFD RSs, called “q̅₀”, and a set of beam identification RSs, called “q̅₁”. RSs in the two sets of BFD RSs may correspond to different beams. If all RSs in q̅₀ fails (that is, their corresponding L1-RSRP measurements are below a predetermined threshold Q_{out, LR}), the terminal device 130 will monitor RSs in q̅₁ to find a new candidate beam. For example, if a RS in q̅₁ is identified as good (that is, its L1-RSRP measurement is equal to or larger than a predetermined threshold Q_{in, LR}), the terminal device 130 may send a beam failure recovery request to the network device 110 with the new identified RS. The terminal device 130 may monitor PDCCH candidate(s) with the new identified RS to detect a beam failure recovery response from the network device 110. In response to receiving the beam failure recovery response indicating a beam recovery acknowledgement from the network device 110, the beam failure can be considered to be recovered.

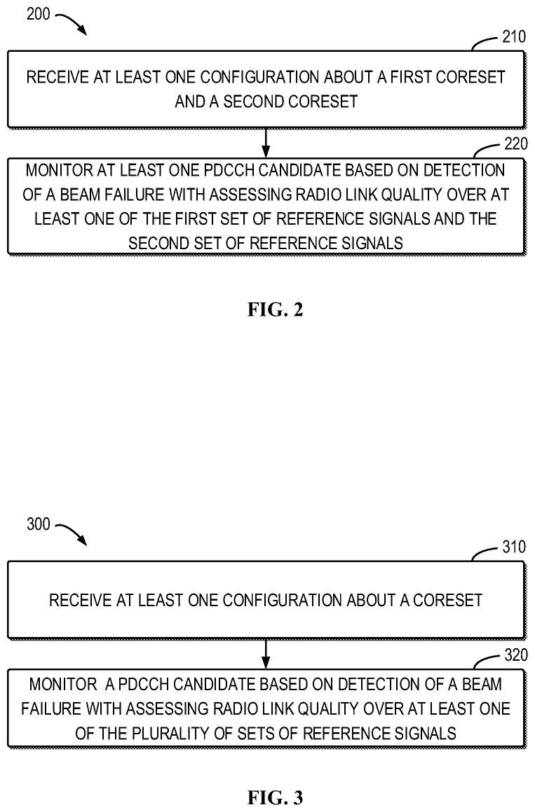

As described above, in the non-SFN scheme, PDCCH repetitions can be enabled to improve reliability and robustness for PDCCH. FIG. 2 illustrates a flowchart of an example method 200 for the non-SFN scheme in accordance with some embodiments of the present disclosure. The method 200 can be implemented at the terminal device 130 as shown in FIG. 1.

As shown in FIG. 2, at block 210, the terminal device 130 receives, from the network device 110, at least one configuration about a first CORESET and a second CORESET.

In some embodiments, the at least one configuration may configure a first set of search spaces which is associated with the first CORESET. In some embodiments, the at least one configuration may configure a second set of search spaces which is associated with the second CORESET. In some embodiments, the at least one configuration may configure a first set of PDCCH candidates in a first search space of the first set of search spaces. In some embodiments, the at least one configuration may configure a second set of PDCCH candidates in a second search space of the second set of search spaces. In some embodiments, the at least one configuration may configure that a first PDCCH candidate in the first search space of the first set of search spaces associated with the first CORESET is linked or associated or related to a second PDCCH candidate in the second search space of the second set of search spaces associated with the second CORESET. For example, the terminal device knows the linking or association or relationship before decoding the PDCCH or DCI in the first and second PDCCH candidates. In some embodiments, the first and second PDCCH candidates may be used for PDCCH repetitions. For example, encoding and/or rate matching of the PDCCH or DCI in the PDCCH in the first PDCCH candidate and/or the second PDCCH candidate is based on one repetition (for example, PDCCH or DCI in the PDCCH in one of the first and second PDCCH candidates). For example, the same coded bits are repeated for the other repetition. For another example, each repetition has the same number of control channel elements (CCEs) and coded bits, and corresponds to the same DCI payload. In some embodiments, the at least one configuration may indicate that the first CORESET is associated with a first set of RSs for BFD, and the second CORESET is associated with the first set of RSs or a second set of RSs for BFD. In some embodiments, the first CORESET may be associated with a first set of RSs for BFD without configuration, and the second CORESET may be associated with the first set of RSs or a second set of RSs for BFD without configuration. In some embodiments, the at least one configuration may be transmitted/received via at least one of RRC signaling, MAC CE and DCI. In some embodiments, at least one of the first set of RSs and the second set of RSs may be configured via at least one of RRC signaling, MAC CE and DCI. In some embodiments, there may be none of the first set of RSs and the second set of RSs configured via at least one of RRC signaling, MAC CE and DCI.

In some embodiments, the first CORESET and the second CORESET may be associated with two different sets of RSs for BFD. For example, the first CORESET (also referred to as “CORESET A”) may be associated with a first set of RSs for BFD (also referred to as “BFD RS set S1”) and the second CORESET (also referred to as “CORESET B”) may be associated with a second set of RSs for BFD (also referred to as “BFD RS set S2”). In some embodiments, the number of RSs comprised in the BFD RS set S1 may be any of {1, 2, 3, 4}. The number of RSs comprised in the BFD RS set S2 may be any of {1, 2, 3, 4}. In some embodiments, CORESET A may be associated with a first value of an identity (ID) and CORESET B may be associated with a second value of the ID. For example, CORESET A may be configured with ID=X and CORESET B may be configured with ID=Y, where X and Y may be selected from a value set W and W={N/A, 0, 1}. For example, X may be different from Y. For example, the ID may be the same as CORESETPoolIndex. That is, two different BFS RS sets S1 and S2 are associated with CORESETs with different values of CORESETPoolIndex.

In some embodiments, the first CORESET (that is, CORESET A) and the second CORESET (that is, CORESET B) may be associated with one set of RSs for BFD. In some embodiments, CORESET A and CORESET B may be associated with a same value of an ID (e.g., ID1). In this case, for example, CORESET A and CORESET B may be configured with ID1=X or Y, where X and Y may be selected from a value set W and W={N/A, 0, 1}. For example, CORESET A and CORESET B may be associated with a BFD RS set from either one of S1 or S2. In some embodiments, CORESET A and CORESET B may be associated with a same value of an ID (e.g., ID2). For example, ID2 may have a different value from any one in the value set W. For example, ID2 may be 2 or 3. In this case, for example, CORESET A and CORESET B may be associated with a separate BFD RS set, such as, S3, which is different from any of S1 and S2. For example, the BFD RS set S3 may include up to 2 RSs and each RS may be QCLed or associated with the TCI state for CORESET A or CORESET B. For example, for each set/pair of CORESETs with linked search space sets or linked PDCCH candidates, there may be an associated separate set of BFD RSs.

At block 220, the terminal device 130 monitors at least one PDCCH candidate based on detection of a beam failure with assessing radio link quality over at least one of the first set of RSs and the second set of RSs.

In some embodiment, when radio link quality for all corresponding resource configurations in at least one BFD RS set (for example, S1 or S2 or S3) or when radio link quality for at least one corresponding resource configurations in the BFD RS set (for example, S3) that the terminal device 130 used to access the radio link quality is worse than the threshold Q_{out,LR}, it means that the BFD RS set fails or one TRP/link fails.

In some embodiments, CORESET A and CORESET B may be associated with two different BFD RS sets S1 and S2 respectively. In some embodiments, if a beam failure is not detected over any of S1 and S2, the terminal device 130 may monitor at least one of the first PDCCH candidate and the second PDCCH candidate. In some embodiments, if a beam failure is detected over at least one of S1 and S2, the terminal device 130 may monitor either the first PDCCH candidate or the second PDCCH candidate. In some embodiments, if a beam failure is detected over at least one of S1 and S2, the terminal device 130 may monitor neither of the first PDCCH candidate and the second PDCCH candidate. For example, if a beam failure is detected over S2, the terminal device 130 may monitor the first PDCCH candidate without monitoring the second PDCCH candidate. For another example, if a beam failure is detected over S2, the terminal device 130 may determine or decide not to monitor the second PDCCH candidate or the terminal device 130 may drop or discard or ignore the second PDCCH candidate. Alternatively, or in addition, if a beam failure is detected over S1, the terminal device 130 may monitor the second PDCCH candidate without monitoring the first PDCCH candidate. Alternatively, or in addition, if a beam failure is detected over S1, the terminal device 130 may determine or decide not to monitor the first PDCCH candidate or the terminal device 130 may drop or discard or ignore the first PDCCH candidate. Alternatively, or in addition, if a beam failure is detected over at least one of S1 and S2, the terminal device 130 may monitor neither of the first PDCCH candidate and the second PDCCH candidate. Alternatively, or in addition, if a beam failure is detected over at least one of S1 and S2, the terminal device 130 may determine or decide not to monitor any one of the first PDCCH candidate and the second PDCCH candidate or the terminal device 130 may drop or discard or ignore the first PDCCH candidate and the second PDCCH candidate.

In some embodiment, CORESET A and CORESET B may be associated with one BFD RS set (for example, S1 or S2 or S3). The BFD RS set may include a first RS and a second RS. In some embodiments, if a beam failure is detected over the second RS, the terminal device 130 may monitor the first PDCCH candidate without monitoring the second PDCCH candidate. Alternatively, or in addition, if a beam failure is detected over the second RS, the terminal device 130 may determine or decide not to monitor the second PDCCH candidate or the terminal device 130 may drop or discard or ignore the second PDCCH candidate. In some embodiments, if a beam failure is detected over the first RS, the terminal device 130 may monitor the second PDCCH without monitoring the first PDCCH candidate. Alternatively, or in addition, if a beam failure is detected over the first RS, the terminal device 130 may determine or decide not to monitor the first PDCCH candidate or the terminal device 130 may drop or discard or ignore the first PDCCH candidate. Alternatively, or in addition, if a beam failure is detected at least one of the first and second RSs, the terminal device 130 may monitor neither of the first PDCCH candidate and the second PDCCH candidate. Alternatively, or in addition, if a beam failure is detected over at least one of the first RS and the second RS, the terminal device 130 may determine or decide not to monitor any one of the first PDCCH candidate and the second PDCCH candidate or the terminal device 130 may drop or discard or ignore the first PDCCH candidate and the second PDCCH candidate.

In some embodiment, the terminal device 130 may decode/detect DCI associated with at least one of the following: the first PDCCH candidate, the second PDCCH candidate and a combination of the first PDCCH candidate and the second PDCCH candidate.

In some embodiments, CORESET A and CORESET B may be associated with two different BFD RS sets S1 and S2 respectively. In some embodiments, if a beam failure is not detected over any of S1 and S2, the terminal device 130 may decode/detect the DCI associated with at least one of the first PDCCH candidate, the second PDCCH candidate and a combination of the first PDCCH candidate and the second PDCCH candidate. In some embodiments, if a beam failure is detected over at least one of S1 and S2, the terminal device 130 may decode/detect the DCI associated with one of the first PDCCH candidate and the second PDCCH candidate. For example, if a beam failure is detected over S1, the terminal device 130 may decode/detect the DCI associated with the second PDCCH candidate without decoding the DCI associated with the first PDCCH candidate. For another example, if a beam failure is detected over S1, the terminal device 130 may determine or decide not to decode/detect the DCI associated with the first PDCCH candidate or the terminal device 130 may drop or discard or ignore the DCI associated with the first PDCCH candidate. In some embodiments, if a beam failure is detected over S1, the terminal device 130 may decode/detect the DCI associated with the combination of the first PDCCH candidate and the second PDCCH candidate by setting a weight associated with the first PDCCH candidate to be 0. In some embodiments, if a beam failure is detected over S2, the terminal device 130 may decode/detect the DCI associated with the first PDCCH candidate without decoding the DCI associated with the second PDCCH candidate. For example, if a beam failure is detected over S2, the terminal device 130 may determine or decide not to decode/detect the DCI associated with the second PDCCH candidate or the terminal device 130 may drop or discard or ignore the DCI associated with the second PDCCH candidate. In some embodiments, if a beam failure is detected over S2, the terminal device 130 may decode/detect the DCI associated with the combination of the first PDCCH candidate and the second PDCCH candidate by setting a weight associated with the second PDCCH candidate to be 0. In some embodiments, if a beam failure is detected over at least one of S1 and S2, the terminal device 130 may not decode/detect the DCI associated with any one of the first PDCCH candidate and the second PDCCH candidate. For example, if a beam failure is detected over at least one of S1 and S2, the terminal device 130 may determine or decide not to decode/detect the DCI associated with any one of the first PDCCH candidate and the second PDCCH candidate or the terminal device 130 may drop or discard or ignore the DCI associated with any one of the first PDCCH candidate and the second PDCCH candidate. Alternatively, if a beam failure is detected over at least one of S1 and S2, the terminal device 130 may not decode/detect the DCI associated with the combination of the first PDCCH candidate and the second PDCCH candidate. For example, if a beam failure is detected over at least one of S1 and S2, the terminal device 130 may determine or decide not to decode/detect the DCI associated with the combination of the first PDCCH candidate and the second PDCCH candidate or the terminal device 130 may drop or discard or ignore the DCI associated with the combination of the first PDCCH candidate and the second PDCCH candidate.

In some embodiments, CORESET A and CORESET B may be associated with one BFD RS set (for example, S1 or S2 or S3). The BFD RS set may include a first RS and a second RS. In some embodiments, if a beam failure is not detected over any one of the first RS and the second RS, the terminal device 130 may decode/detect the DCI associated with at least one of the first PDCCH candidate, the second PDCCH candidate and a combination of the first PDCCH candidate and the second PDCCH candidate. In some embodiments, if a beam failure is detected over at least one of the first RS and the second RS, the terminal device 130 may decode/detect the DCI associated with one of the first PDCCH candidate and the second PDCCH candidate. In some embodiments, if a beam failure is detected over the first RS, the terminal device 130 may decode/detect the DCI associated with the second PDCCH candidate, without decoding the DCI associated with the first PDCCH candidate. In some embodiments, if a beam failure is detected over the first RS, the terminal device 130 may determine or decide not to decode/detect the DCI associated with the first PDCCH candidate or the terminal device 130 may drop or discard or ignore the DCI associated with the first PDCCH candidate. In some embodiments, if a beam failure is detected over the first RS, the terminal device 130 may decode the DCI associated with the combination of the first PDCCH candidate and the second PDCCH candidate by setting a weight associated with the first PDCCH candidate to be 0. In some embodiments, if a beam failure is detected over the second RS, the terminal device 130 may decode the DCI associated with the first PDCCH candidate, without decoding the DCI associated with the second PDCCH candidate. In some embodiments, if a beam failure is detected over the second RS, the terminal device 130 may determine or decide not to decode/detect the DCI associated with the second PDCCH candidate or the terminal device 130 may drop or discard or ignore the DCI associated with the second PDCCH candidate. In some embodiments, if a beam failure is detected over the second RS, the terminal device 130 may decode the DCI associated with the combination of the first PDCCH candidate and the second PDCCH candidate by setting a weight associated with the second PDCCH candidate to be 0. In some embodiments, if a beam failure is detected over at least one of the first and second RSs, the terminal device 130 may not decode the DCI associated with any one of the first PDCCH candidate and the second PDCCH candidate. For example, if a beam failure is detected over at least one of the first RS and the second RS, the terminal device 130 may determine or decide not to decode/detect the DCI associated with any one of the first PDCCH candidate and the second PDCCH candidate or the terminal device 130 may drop or discard or ignore the DCI associated with any one of the first PDCCH candidate and the second PDCCH candidate. In some embodiments, if a beam failure is detected over at least one of the first and second RSs, the terminal device 130 may not decode the DCI associated with the combination of the first PDCCH candidate and the second PDCCH candidate. For example, if a beam failure is detected over at least one of the first RS and the second RS, the terminal device 130 may determine or decide not to decode/detect the DCI associated with the combination of the first PDCCH candidate and the second PDCCH candidate or the terminal device 130 may drop or discard or ignore the DCI associated with the combination of the first PDCCH candidate and the second PDCCH candidate.

In some embodiment, the terminal device 130 may receive both of the first set of RSs (that is, S1) and the second set of RSs (that is, S2) via at least one of Radio Resource Control (RRC) signaling, Medium Access Control (MAC) control element (CE) and DCI. Alternatively, the terminal device 130 may receive none of the first set of RSs and the second set of RSs via at least one of RRC signaling, MAC CE and DCI. Alternatively, the terminal device 130 may receive only the first set of RSs via at least one of RRC signaling, MAC CE and DCI; or the terminal device 130 may not receive the first set of RSs via at least one of RRC signaling, MAC CE and DCI. Alternatively, the terminal device 130 may receive only the second set of RSs via at least one of RRC signaling, MAC CE and DCI; or the terminal device 130 may not receive the second set of RSs via at least one of RRC signaling, MAC CE and DCI. In some embodiments, the terminal device 130 may receive both of the first RS and second RS via at least one of RRC signaling, MAC CE and DCI. Alternatively, the terminal device 130 may receive none of the first RS and second RS via at least one of RRC signaling, MAC CE and DCI. Alternatively, the terminal device 130 may receive only the first RS via at least one of RRC signaling, MAC CE and DCI; or the terminal device 130 may not receive the first RS via at least one of RRC signaling, MAC CE and DCI. Alternatively, the terminal device 130 may receive only the second RS via at least one of RRC signaling, MAC CE and DCI; or the terminal device 130 may not receive the second RS via at least one of RRC signaling, MAC CE and DCI.

In some embodiments, if the first set of RSs is not received by the terminal device 130, the terminal device 130 may determine the first set of RSs based on either one of: a third set of RSs indicated in a first TCI state for the first CORESET; or a third set of RSs indicated in the first TCI state for the first CORESET and a fourth set of RSs indicated in a second TCI state for the second CORESET. In some embodiments, if the second set of RSs is not received by the terminal device 130, the terminal device 130 may determine the second set of RSs based on the fourth set of RSs indicated in the second TCI state for the second CORESET. In some embodiments, if the first RS is not received by the terminal device 130, the terminal device 130 may determine the first RS based on either one of: a third set of RSs indicated in a first TCI state for the first CORESET; or a third set of RSs indicated in the first TCI state for the first CORESET and a fourth set of RSs indicated in a second TCI state for the second CORESET. In some embodiments, if the second RS is not received by the terminal device 130, the terminal device 130 may determine the second RS based on the fourth set of RSs indicated in the second TCI state for the second CORESET.

In some embodiments, for the PDCCH repetition scheme, if a beam failure occurs, the terminal device 130 may identify two new beams or two RSs. For example, two CSI-RS configuration indexes or two SS/PBCH block indexes or one CSI-RS configuration index and one SS/PBCH block index. In some embodiments, in case that CORESET A and CORESET B are associated with a same BFD RS set, the terminal device 130 may indicate to higher layers whether there is at least two periodic CSI-RS configuration indexes or two SS/Physical Broadcast Channel (PBCH) block indexes or at least one periodic CSI-RS configuration index and one SS/Physical Broadcast Channel (PBCH) block index from the new beam candidate set q1 with corresponding L1-RSRP measurements that are larger than or equal to the Q_{in,LR} threshold, and provides two periodic CSI-RS configuration indexes and/or two SS/PBCH block indexes and/or one periodic CSI-RS configuration indexes and one SS/PBCH block index from the set q1 and the corresponding L1-RSRP measurements that are larger than or equal to the Q_{in,LR} threshold, if any. Regarding the candidate RS ID, both first and second fields are set to the index of an SSB with SS-RSRP above rsrp-ThresholdBFR amongst the SSBs in candidate beam list or to the index of a CSI-RS with CSI-RSRP above rsrp-ThresholdBFR amongst the CSI-RSs in candidate beam list. Index of an SSB or CSI-RS is the index of an entry in candidate beam list corresponding to the SSB or CSI-RS. Index 0 corresponds to the first entry in the candidate beam list, index 1 corresponds to the second entry in the list and so on. The length of this field is 12 bits.

In some embodiments, CORESET A and CORESET B may be associated with two different BFD RS sets, for example, a first set of RSs (that is, S1) and a second set of RSs (that is, S2) respectively. In this case, if a beam failure is detected over S1, the terminal device 130 may identify a third RS from a fifth set of RSs. In some embodiments, CORESET A and CORESET B may be associated with one BFD RS set (for example, S1 or S2 or S3). The BFD RS set may include a first RS and a second RS. In this case, if a first beam failure is detected over the first RS, the terminal device 130 may identify a third RS from a fifth set of RSs. In some embodiments, the terminal device 130 may monitor the first PDCCH candidate using a first set of antenna port QCL parameters as those associated with the third RS. In some embodiments, the terminal device 130 may monitor the second PDCCH candidate with the second TCI state for the second CORESET. In some embodiments, the terminal device 130 may monitor neither of the first and second PDCCH candidates. In some embodiments, if a beam failure is detected over S1, the terminal device 130 may determine or decide not to monitor any one of the first PDCCH candidate and the second PDCCH candidate or the terminal device 130 may drop or discard or ignore the first PDCCH candidate and the second PDCCH candidate.

In some embodiments, CORESET A and CORESET B may be associated with two different BFD RS sets, for example, a first set of RSs (that is, S1) and a second set of RSs (that is, S2) respectively. In this case, if a beam failure is detected over S2, the terminal device 130 may identify a fourth RS from a sixth set of RSs. In some embodiments, CORESET A and CORESET B may be associated with one BFD RS set (for example, S1 or S2 or S3). The BFD RS set may include a first RS and a second RS. In this case, if a first beam failure is detected over the second RS, the terminal device 130 may identify a fourth RS from a sixth set of RSs. In some embodiments, the terminal device 130 may monitor the second PDCCH candidate using a second set of antenna port QCL parameters as those associated with the fourth RS. In some embodiments, the terminal device 130 may monitor the first PDCCH candidate with the first TCI state for the first CORESET. In some embodiments, the terminal device 130 may monitor neither of the first and second PDCCH candidates. In some embodiments, if a beam failure is detected over S2, the terminal device 130 may determine or decide not to monitor any one of the first PDCCH candidate and the second PDCCH candidate or the terminal device 130 may drop or discard or ignore the first PDCCH candidate and the second PDCCH candidate.

In some embodiments, if the third RS is identified and the fourth RS is not identified, the terminal device 130 may monitor the first PDCCH candidate using the first set of antenna port QCL parameters as those associated with the third RS, without monitoring the second PDCCH candidate. In some embodiments, if the third RS is identified and the fourth RS is not identified, the terminal device 130 may monitor the first PDCCH candidate using the first set of antenna port QCL parameters as those associated with the third RS. In some embodiments, if the third RS is identified and the fourth RS is not identified, the terminal device 130 may determine or decide not to monitor the second PDCCH candidate or the terminal device 130 may drop or discard or ignore the second PDCCH candidate. In some embodiments, if the third RS is not identified and the fourth RS is identified, the terminal device 130 may monitor the second PDCCH candidate using the second set of antenna port QCL parameters as those associated with the fourth RS, without monitoring the first PDCCH candidate. In some embodiments, if the third RS is not identified and the fourth RS is identified, the terminal device 130 may monitor the second PDCCH candidate using the second set of antenna port QCL parameters as those associated with the fourth RS. In some embodiments, if the third RS is not identified and the fourth RS is identified, the terminal device 130 may determine or decide not to monitor the first PDCCH candidate or the terminal device 130 may drop or discard or ignore the first PDCCH candidate. In some embodiments, if at least one of the third RS and the fourth RS is not identified, the terminal device 130 may monitor neither of the first PDCCH candidate and the second PDCCH candidate. In some embodiments, if at least one of the third RS and the fourth RS is not identified, the terminal device 130 may determine or decide not to monitor any one of the first PDCCH candidate and the second PDCCH candidate or the terminal device 130 may drop or discard or ignore the first PDCCH candidate and the second PDCCH candidate.

In some embodiments, CORESET A and CORESET B may be associated with one BFD RS set (for example, S1 or S2 or S3). The BFD RS set may include a first RS and a second RS. In some embodiments, if a beam failure is detected over at least one of the first RS and the second RS or over the BFD RS set, the terminal device 130 may identify at least one of a fifth RS and a sixth RS from a seventh set of RSs. In some embodiments, in response to the fifth RS being identified, the terminal device 130 may monitor the first PDCCH candidate using a third set of antenna port QCL parameters as those associated with the fifth RS. In some embodiments, in response to the sixth RS being identified, the terminal device 130 may monitor the second PDCCH candidate using a fourth set of antenna port quasi co-location (QCL) parameters as the ones associated with the sixth RS. Alternatively, in some embodiments, if a beam failure is detected over at least one of the first RS and the second RS or over the BFD RS set, the terminal device 130 may monitor neither of the first PDCCH candidate and the second PDCCH candidate. In some embodiments, if a beam failure is detected over at least one of the first RS and the second RS or over the BFD RS set, the terminal device 130 may determine or decide not to monitor any one of the first PDCCH candidate and the second PDCCH candidate or the terminal device 130 may drop or discard or ignore the first PDCCH candidate and the second PDCCH candidate.

In some embodiments, if the fifth RS is identified and the sixth RS is not identified, the terminal device 130 may monitor the first PDCCH candidate using the third set of antenna port QCL parameters as those associated with the fifth RS, without monitoring the second PDCCH candidate. In some embodiments, if the fifth RS is identified and the sixth RS is not identified, the terminal device 130 may monitor the first PDCCH candidate using the third set of antenna port QCL parameters as those associated with the fifth RS. In some embodiments, if the fifth RS is identified and the sixth RS is not identified, the terminal device 130 may determine or decide not to monitor the second PDCCH candidate or the terminal device 130 may drop or discard or ignore the second PDCCH candidate. In some embodiments, if the fifth RS is not identified and the sixth RS is identified, the terminal device 130 may monitor the second PDCCH candidate using the fourth set of antenna port QCL parameters as those associated with the sixth RS, without monitoring the first PDCCH candidate. In some embodiments, if the fifth RS is not identified and the sixth RS is identified, the terminal device 130 may monitor the second PDCCH candidate using the fourth set of antenna port QCL parameters as those associated with the sixth RS. In some embodiments, if the fifth RS is not identified and the sixth RS is identified, the terminal device 130 may determine or decide not to monitor the first PDCCH candidate or the terminal device 130 may drop or discard or ignore the first PDCCH candidate. In some embodiments, if at least one of the fifth RS and the sixth RS is not identified, the terminal device 130 may monitor neither of the first PDCCH candidate and the second PDCCH candidate. In some embodiments, if at least one of the fifth RS and the sixth RS is not identified, the terminal device 130 may determine or decide not to monitor any one of the first PDCCH candidate and the second PDCCH candidate or the terminal device 130 may drop or discard or ignore the first PDCCH candidate and the second PDCCH candidate.

In some embodiments, CORESET A and CORESET B may be associated with two different BFD RS sets, for example, a first set of RSs (that is, S1) and a second set of RSs (that is, S2) respectively. In this case, if a beam failure is detected over S1, the terminal device 130 may identify a third RS from a fifth set of RSs. In some embodiments, CORESET A and CORESET B may be associated with one BFD RS set (for example, S1 or S2 or S3). The BFD RS set may include a first RS and a second RS. In this case, if a first beam failure is detected over the first RS, the terminal device 130 may identify a third RS from a fifth set of RSs. In some embodiments, in response to the third RS being identified, the terminal device 130 may decode the DCI associated with the first PDCCH candidate using a first set of antenna port QCL parameters as those associated with the third RS. In some embodiments, the terminal device 130 may decode the DCI associated with the second PDCCH candidate with the second TCI state for the second CORESET. In some embodiments, the terminal device 130 may decode the DCI associated with the combination of the first PDCCH and the second PDCCH candidate. In some embodiments, the terminal device 130 may not decode the DCI associated with the combination of the first PDCCH candidate and the second PDCCH candidate. In some embodiments, the terminal device 130 may determine or decide not to decode/detect the DCI associated with the combination of the first PDCCH candidate and the second PDCCH candidate or the terminal device 130 may drop or discard or ignore the DCI associated with the combination of the first PDCCH candidate and the second PDCCH candidate. In some embodiments, the terminal device 130 may not decode the DCI associated with any one of the first PDCCH candidate and the second PDCCH candidate. In some embodiments, the terminal device 130 may determine or decide not to decode/detect the DCI associated with any one of the first PDCCH candidate and the second PDCCH candidate and the combination of the first PDCCH candidate and the second PDCCH candidate or the terminal device 130 may drop or discard or ignore the DCI associated with any one of the first PDCCH candidate and the second PDCCH candidate and the combination of the first PDCCH candidate and the second PDCCH candidate.

In some embodiments, CORESET A and CORESET B may be associated with two different BFD RS sets, for example, a first set of RSs (that is, S1) and a second set of RSs (that is, S2) respectively. In this case, if a beam failure is detected over S2, the terminal device 130 may identify a fourth RS from a sixth set of RSs. In some embodiments, CORESET A and CORESET B may be associated with one BFD RS set (for example, S1 or S2 or S3). The BFD RS set may include a first RS and a second RS. In this case, if a first beam failure is detected over the second RS, the terminal device 130 may identify a fourth RS from a sixth set of RSs. In some embodiments, in response to the third RS being identified, the terminal device 130 may decode the DCI associated with the second PDCCH candidate using a second set of antenna port QCL parameters as those associated with the fourth RS. In some embodiments, the terminal device 130 may decode the DCI associated with the first PDCCH candidate with the first TCI state for the first CORESET. In some embodiments, the terminal device 130 may decode the DCI associated with the combination of the first PDCCH and the second PDCCH candidate. In some embodiments, the terminal device 130 may not decode the DCI associated with the combination of the first PDCCH candidate and the second PDCCH candidate. In some embodiments, the terminal device 130 may determine or decide not to decode/detect the DCI associated with the combination of the first PDCCH candidate and the second PDCCH candidate or the terminal device 130 may drop or discard or ignore the DCI associated with the combination of the first PDCCH candidate and the second PDCCH candidate. In some embodiments, the terminal device 130 may not decode the DCI associated with any one of the first PDCCH candidate and the second PDCCH candidate. In some embodiments, the terminal device 130 may determine or decide not to decode/detect the DCI associated with any one of the first PDCCH candidate and the second PDCCH candidate and the combination of the first PDCCH candidate and the second PDCCH candidate or the terminal device 130 may drop or discard or ignore the DCI associated with any one of the first PDCCH candidate and the second PDCCH candidate and the combination of the first PDCCH candidate and the second PDCCH candidate.

In some embodiments, if the third RS is identified and the fourth RS is not identified, the terminal device 130 may decode the DCI associated with the first PDCCH candidate using the first set of antenna port QCL parameters as those associated with the third RS, without decoding the DCI associated with the second PDCCH candidate and without decoding the DCI associated with the combination of the first PDCCH candidate and the second PDCCH candidate. In some embodiments, if the third RS is identified and the fourth RS is not identified, the terminal device 130 may decode the DCI associated with the first PDCCH candidate using the first set of antenna port QCL parameters as those associated with the third RS. In some embodiments, if the third RS is identified and the fourth RS is not identified, the terminal device 130 may determine or decide not to decode/detect the DCI associated with any one of the second PDCCH candidate and the combination of the first PDCCH candidate and the second PDCCH candidate or the terminal device 130 may drop or discard or ignore the DCI associated with any one of the second PDCCH candidate and the combination of the first PDCCH candidate and the second PDCCH candidate. In some embodiments, if the third RS is not identified and the fourth RS is identified, the terminal device 130 may decode the DCI associated with the second PDCCH candidate using the second set of antenna port QCL parameters as those associated with the third RS, without decoding the DCI associated with the first PDCCH candidate and without decoding the DCI associated with the combination of the first PDCCH candidate and the second PDCCH candidate. In some embodiments, if the third RS is not identified and the fourth RS is identified, the terminal device 130 may decode the DCI associated with the second PDCCH candidate using the second set of antenna port QCL parameters as those associated with the third RS. In some embodiments, if the third RS is not identified and the fourth RS is identified, the terminal device 130 may determine or decide not to decode/detect the DCI associated with any one of the first PDCCH candidate and the combination of the first PDCCH candidate and the second PDCCH candidate or the terminal device 130 may drop or discard or ignore the DCI associated with any one of the first PDCCH candidate and the combination of the first PDCCH candidate and the second PDCCH candidate. In some embodiments, if at least one of the third RS and the fourth RS is not identified, the terminal device 130 may not decode the DCI associated with at least one of: the first PDCCH candidate, the second PDCCH candidate, and the combination of the first PDCCH candidate and the second PDCCH candidate. In some embodiments, if at least one of the third RS and the fourth RS is not identified, the terminal device 130 may determine or decide not to decode/detect the DCI associated with any one of the first PDCCH candidate and the second PDCCH candidate and the combination of the first PDCCH candidate and the second PDCCH candidate or the terminal device 130 may drop or discard or ignore the DCI associated with any one of the first PDCCH candidate and the second PDCCH candidate and the combination of the first PDCCH candidate and the second PDCCH candidate.

In some embodiments, CORESET A and CORESET B may be associated with one BFD RS set (for example, S1 or S2 or S3). The BFD RS set may include a first RS and a second RS. In some embodiments, if a beam failure is detected over at least one of the first RS and the second RS or over the BFD RS set, the terminal device 130 may identify at least one of a fifth RS and a sixth RS from a seventh set of RSs. In some embodiments, in response to the fifth RS being identified, the terminal device 130 may decode the DCI associated with the first PDCCH candidate using a third set of antenna port QCL parameters as those associated with the fifth RS. In some embodiments, in response to the sixth RS being identified, the terminal device 130 may decode the DCI associated with the second PDCCH candidate using a fourth set of antenna port QCL parameters as those associated with the sixth RS. In some embodiments, the terminal device 130 may not decode the DCI associated with the combination of the first PDCCH candidate and the second PDCCH candidate. In some embodiments, the terminal device 130 may determine or decide not to decode/detect the DCI associated with the combination of the first PDCCH candidate and the second PDCCH candidate or the terminal device 130 may drop or discard or ignore the DCI associated with the combination of the first PDCCH candidate and the second PDCCH candidate. In some embodiments, the terminal device 130 may not decode the DCI associated with any one of the first PDCCH candidate and the second PDCCH candidate. In some embodiments, the terminal device 130 may determine or decide not to decode/detect the DCI associated with any one of the first PDCCH candidate and the second PDCCH candidate and the combination of the first PDCCH candidate and the second PDCCH candidate or the terminal device 130 may drop or discard or ignore the DCI associated with any one of the first PDCCH candidate and the second PDCCH candidate and the combination of the first PDCCH candidate and the second PDCCH candidate.

In some embodiments, if the fifth RS is identified and the sixth RS is not identified, the terminal device 130 may decode the DCI associated with the first PDCCH candidate using the third set of antenna port QCL parameters as those associated with the fifth RS, without decoding at least one of the DCI associated with the second PDCCH candidate and the DCI associated with the combination of the first PDCCH candidate and the second PDCCH candidate. In some embodiments, if the fifth RS is identified and the sixth RS is not identified, the terminal device 130 may decode the DCI associated with the first PDCCH candidate using the third set of antenna port QCL parameters as those associated with the fifth RS. In some embodiments, if the fifth RS is identified and the sixth RS is not identified, the terminal device 130 may determine or decide not to decode/detect the DCI associated with any one of the second PDCCH candidate and the combination of the first PDCCH candidate and the second PDCCH candidate or the terminal device 130 may drop or discard or ignore the DCI associated with any one of the second PDCCH candidate and the combination of the first PDCCH candidate and the second PDCCH candidate. In some embodiments, if the fifth RS is not identified and the sixth RS is identified, the terminal device 130 may decode the DCI associated with the second PDCCH candidate using the fourth set of antenna port QCL parameters as those associated with the sixth RS, without decoding at least one of the DCI associated with the first PDCCH candidate and the DCI associated with the combination of the first PDCCH candidate and the second PDCCH candidate. In some embodiments, if the fifth RS is not identified and the sixth RS is identified, the terminal device 130 may decode the DCI associated with the second PDCCH candidate using the fourth set of antenna port QCL parameters as those associated with the sixth RS. In some embodiments, if the fifth RS is not identified and the sixth RS is identified, the terminal device 130 may determine or decide not to decode/detect the DCI associated with any one of the first PDCCH candidate and the combination of the first PDCCH candidate and the second PDCCH candidate or the terminal device 130 may drop or discard or ignore the DCI associated with any one of the first PDCCH candidate and the combination of the first PDCCH candidate and the second PDCCH candidate. In some embodiments, if at least one of the fifth RS and the sixth RS is not identified, the terminal device 130 may not decode at least one of: the DCI associated with the first PDCCH candidate, the DCI associated with the second PDCCH candidate and the DCI associated with the combination of the first PDCCH candidate and the second PDCCH candidate. In some embodiments, if at least one of the fifth RS and the sixth RS is not identified, the terminal device 130 may determine or decide not to decode/detect the DCI associated with any one of the first PDCCH candidate and the second PDCCH candidate and the combination of the first PDCCH candidate and the second PDCCH candidate or the terminal device 130 may drop or discard or ignore the DCI associated with any one of the first PDCCH candidate and the second PDCCH candidate and the combination of the first PDCCH candidate and the second PDCCH candidate.

In some embodiments, the at least one PDCCH candidate may be monitored starting from or after a time point. For example, the time point may be a slot or a symbol. The terminal device 130 may decode the DCI associated with the first PDCCH candidate starting from or after the time point. Alternatively, or in addition, the terminal device 130 may decode the DCI associated with the second PDCCH candidate starting from or after the time point. Alternatively, or in addition, the terminal device 130 may decode the DCI associated with the combination of the first PDCCH candidate and the second PDCCH candidate starting from or after the time point. In some embodiments, the time point may be 28 symbols from a last symbol of a first PDCCH reception in a search set provided by recoverySeaerchSpaceId for which the terminal device detects a DCI with Cyclic redundancy check (CRC) scrambled by Cell Radio Network Temporary Identifier (C-RNTI) or Modulation and coding scheme Cell Radio Network Temporary Identifier (MCS-C-RNTI). In some embodiments, the time point may be 28 symbols from a last symbol of a PDCCH reception with a DCI scheduling a PUSCH transmission with a same hybrid automatic repeat request (HARQ) process number as for the transmission of the first PUSCH and having a toggled New Data Indicator (NDI) field value.

In some embodiments, for PDCCH repetitions, detection/decoding of the combination of the first and second PDCCH candidates may be counted in the slot/span corresponding to the first or second PDCCH candidate. For example, the terminal device 130 may only decode the combination of the first and second PDCCH candidates without decoding individual first and second PDCCH candidates. In some embodiments, for PDCCH repetitions, blind detection of each individual PDCCH candidate may be counted in each slot/span corresponding to each individual PDCCH candidate respectively. For example, the terminal device 130 may only decode individual PDCCH candidates. In some embodiments, for PDCCH repetitions, blind detection of the first PDCCH candidate may be counted in the slot/span corresponding to the first PDCCH candidate, and blind detection of the combination of the first and second PDCCH candidates may be counted in the slot/span corresponding to the first or second PDCCH candidate. For example, the terminal device 130 may decode the first PDCCH candidate and the combination of the first and second PDCCH candidates. In some embodiments, for PDCCH repetitions, blind detection of each individual PDCCH candidate may counted in each slot/span corresponding to each individual PDCCH candidate respectively, and blind detection of the combination of the first and second PDCCH candidates may be counted in the slot/span corresponding to the first or second PDCCH candidate. For example, the terminal device 130 may decode each PDCCH candidate individually, and also decode the combination of the first and second PDCCH candidates.

As described above, in the SFN scheme, one CORESET or one or more SS sets within one CORESET may be configured with two TCI states (which correspond to different beams), so as to improve reliability and robustness for PDCCH. FIG. 3 illustrates a flowchart of an example method 300 for the SFN scheme in accordance with some embodiments of the present disclosure. The method 300 can be implemented at the terminal device 130 as shown in FIG. 1.

As shown in FIG. 3, at block 310, the terminal device 130 receives, from the network device 110, at least one configuration about a CORESET (also referred to as “CORESET C”). The at least one configuration may indicate at least one of the following: the CORESET is associated with a plurality of sets of RSs for BFD; the CORESET is associated with a first TCI state and a second TCI state; and a PDCCH candidate in a search space associated with the CORESET is associated with a first TCI state and a second TCI state.

In some embodiments, the at least one configuration may indicate that CORESET C is associated with two different sets of RSs for BFD. For example, CORESET C may be associated with a first set of RSs for BFD (also referred to as “BFD RS set S1”) and a second set of RSs for BFD (also referred to as “BFD RS set S2”). In some embodiments, the number of RSs comprised in the BFD RS set S1 may be any of {1, 2, 3, 4}. The number of RSs comprised in the BFD RS set S2 may be any of {1, 2, 3, 4}. In some embodiments, CORESET C may be configured with an ID (e.g., ID1), where ID1 may be selected from a value set W and W={N/A, 0, 1}. In some embodiments, CORESET C may be configured with an ID (e.g., ID3), where ID3 may be a different value from any one in the value set W. For example, ID3 may be 2 or 3.

In some embodiments, if CORESET C is configured with two active TCI states, CORESET C may be associated with both or all configured BFD RS sets (e.g., S1 and S2).

In some embodiments, the at least one configuration may indicate that CORESET C is associated with one set of RSs for BFD. In some embodiments, CORESET C may be associated with S1 or S2. For example, in this case, CORESET C may be configured with a value of an ID (e.g., ID1), where ID1 may be selected from a value set W and W={N/A, 0, 1}. In some embodiments, CORESET C may be associated with a separate BFD RS set, such as, S4, which is different from any of S1, S2 and S3. For example, the number of RSs comprised in the BFD RS set S1 may be any of {1, 2, 3, 4}. For example, the BFD RS set S3 may include up to 2 RSs and each RS may be QCLed or associated with the TCI state for CORESET C. For example, for each set/pair of CORESETs with linked search space sets, there may be an associated separate set of BFD RSs. For example, in this case, CORESET C may be configured with a value of an ID (e.g., ID1), where ID1 may be selected from a value set W and W={N/A, 0, 1}. For another example, in this case, CORESET C may be configured with a value of an ID (e.g., ID3), where ID3 may be a different value from any one in the value set W. For example, ID3 may be 2 or 3.

At block 320, the terminal device 130 monitors a PDCCH candidate based on detection of a beam failure with assessing radio link quality over at least one of the plurality of sets of RSs.

In some embodiment, when radio link quality for all corresponding resource configurations in one BFD RS set (for example, S1 or S2 or S4) or when radio link quality for at least one corresponding resource configurations in the BFD RS set (for example, S4) that the terminal device 130 used to access the radio link quality is worse than the threshold Q_{out,LR}, it means that the BFD RS set fails or one TRP/link fails.

In some embodiments, if a beam failure is not detected over any one of the plurality of sets of RSs, the terminal device 130 may monitor the PDCCH candidate with the first TI state and the second TCI state. In some embodiments, if a beam failure is detected over at least one of the plurality of sets of RSs, the terminal device 130 may not monitor the PDCCH candidate. In some embodiments, if a beam failure is detected over at least one of the plurality of sets of RSs, the terminal device 130 may determine or decide not to monitor the PDCCH candidate or the terminal device 130 may drop or discard or ignore the PDCCH candidate. In some embodiments, if a beam failure is detected over at least one of the plurality of sets of RSs, the terminal device 130 may monitor the PDCCH candidate with only one of the first TCI state and the second TCI state.

In some embodiment, the plurality of sets of RSs comprises a first set of RSs (that is, S1) and a second set of RSs (that is, S2). In some embodiments, if a beam failure is detected over the second set of RSs, the terminal device 130 may monitor the PDCCH candidate with the first TCI state. Alternatively, or in addition, if a beam failure is detected over the first set of RSs, the terminal device 130 may monitor the PDCCH candidate with the second TCI state. Alternatively, if a beam failure is detected at least one of the first and second RSs, the terminal device 130 may not monitor the PDCCH candidate. In some embodiments, if a beam failure is detected over at least one of the first RS and the second RS, the terminal device 130 may determine or decide not to monitor the PDCCH candidate or the terminal device 130 may drop or discard or ignore the PDCCH candidate.

In some embodiments, the plurality of sets of RSs may comprise a third set of RSs (that is, S1 or S2 or S4) comprising first and second RSs. In some embodiments, if a beam failure is detected over the second RS, the terminal device 130 may monitor the PDCCH candidate with the first TCI state. In some embodiments, if a beam failure is detected over the first RS, the terminal device 130 may monitor the PDCCH candidate with the second TCI state. In some embodiments, if a beam failure is detected over at least one of the first RS and the second RS, the terminal device 130 may not monitor the PDCCH candidate. In some embodiments, if a beam failure is detected over at least one of the first RS and the second RS, the terminal device 130 may determine or decide not to monitor the PDCCH candidate or the terminal device 130 may drop or discard or ignore the PDCCH candidate.

In some embodiment, the terminal device 130 may decode DCI associated with the PDCCH candidate. In some embodiments, if a beam failure being detected over at least one of the plurality of sets of RSs, the terminal device 130 may not decode DCI associated with the PDCCH candidate. In some embodiments, if a beam failure is detected over at least one of the plurality of sets of RSs, the terminal device 130 may determine or decide not to decode the DCI associated with the PDCCH candidate or the terminal device 130 may drop or discard or ignore the DCI associated with the PDCCH candidate.

In some embodiment, the plurality of sets of RSs comprises a first set of RSs (that is, S1) and a second set of RSs (that is, S2). In some embodiments, if a beam failure is not detected over any one of the first set of RSs and the second set of RSs, the terminal device 130 may decode the DCI associated with the PDCCH candidate with the first TCI state and the second TCI state. In some embodiments, if a beam failure is detected over at least one of the first set of RSs and the second set of RSs, the terminal device 130 may decode the DCI associated with the PDCCH candidate with one of the first TCI state and the second TI state. In some embodiments, if a beam failure is detected over at least one of the first set of RSs and the second set of RSs, the terminal device 130 may not decode the DCI associated with the PDCCH candidate with any one of the first TCI state and the second TI state. In some embodiments, if a beam failure is detected over at least one of the first set of RSs and the second set of RSs, the terminal device 130 may not decode the DCI associated with the PDCCH candidate. In some embodiments, if a beam failure is detected over at least one of the first set of RSs and the second set of RSs, the terminal device 130 may determine or decide not to decode the DCI associated with the PDCCH candidate or the terminal device 130 may drop or discard or ignore the DCI associated with the PDCCH candidate.

In some embodiments, if a beam failure is detected over the second set of RSs, the terminal device 130 may decode the DCI associated with the PDCCH candidate with the first TCI state. In some embodiments, if a beam failure is detected over the first set of RSs, the terminal device 130 may decode the DCI associated with the PDCCH candidate with the second TCI state. In some embodiments, if a beam failure is detected over at least one of the first set of RSs and the second set of RSs, the terminal device 130 may not decode the DCI associated with the PDCCH candidate with any one of the first TCI state and the second TCI state. In some embodiments, if a beam failure is detected over at least one of the first set of RSs and the second set of RSs, the terminal device 130 may determine or decide not to decode the DCI associated with the PDCCH candidate with any one of the first TCI state and the second TCI state or the terminal device 130 may drop or discard or ignore the DCI associated with the PDCCH candidate. In some embodiments, if a beam failure is detected over at least one of the first set of RSs and the second set of RSs, the terminal device 130 may not decode the DCI associated with the PDCCH candidate.

In some embodiments, the plurality of sets of RSs comprises a third set of RSs (that is, S1 or S2 or S4) comprising first and second RSs. In some embodiments, if a beam failure is detected over the second RS, the terminal device 130 may decode the DCI associated with the PDCCH candidate with the first TCI state. In some embodiments, if a beam failure is detected over the first RS, the terminal device 130 may decode the DCI associated with the PDCCH candidate with the second TCI state. In some embodiments, if a beam failure is detected over at least one of the first and second RSs, the terminal device 130 may not decode the DCI associated with the PDCCH candidate with any one of the first TI state and the second TCI state. In some embodiments, if a beam failure is detected over at least one of the first RS and the second RS, the terminal device 130 may determine or decide not to decode the DCI associated with the PDCCH candidate or the terminal device 130 may drop or discard or ignore the DCI associated with the PDCCH candidate.

In some embodiment, the terminal device 130 may receive both of the first set of RSs (that is, S1) and the second set of RSs (that is, S2) via at least one of Radio Resource Control (RRC) signaling, Medium Access Control (MAC) control element (CE) and DCI. Alternatively, the terminal device 130 may receive none of the first set of RSs and the second set of RSs via at least one of RRC signaling, MAC CE and DCI. Alternatively, the terminal device 130 may receive only the first set of RSs via at least one of RRC signaling, MAC CE and DCI; or the terminal device 130 may not receive the first set of RSs via at least one of RRC signaling, MAC CE and DCI. Alternatively, the terminal device 130 may receive only the second set of RSs via at least one of RRC signaling, MAC CE and DCI; or the terminal device 130 may not receive the second set of RSs via at least one of RRC signaling, MAC CE and DCI. In some embodiments, the terminal device 130 may receive both of the first RS and second RS via at least one of RRC signaling, MAC CE and DCI. Alternatively, the terminal device 130 may receive none of the first RS and second RS via at least one of RRC signaling, MAC CE and DCI. Alternatively, the terminal device 130 may receive only the first RS via at least one of RRC signaling, MAC CE and DCI; or the terminal device 130 may not receive the first RS via at least one of RRC signaling, MAC CE and DCI. Alternatively, the terminal device 130 may receive only the second RS via at least one of RRC signaling, MAC CE and DCI; or the terminal device 130 may not receive the second RS via at least one of RRC signaling, MAC CE and DCI.

In some embodiments, if the first set of RSs or the first RS is not received by the terminal device 130, the terminal device 130 may determine the first set of RSs or the first RS based on a fourth set of RSs indicated in a first TCI state for the CORESET. In some embodiments, if the second set of RSs or the second RS is not received by the terminal device 130, the terminal device 130 may determine the second set of RSs or the second RS based on a fifth set of RSs indicated in a second TCI state for the CORESET. In some embodiments, the terminal device 130 may determine the third set of RSs based on a combination of the fourth set of RSs indicated in a first TCI state for CORESET C and the fifth set of RSs indicated in the second TCI state for CORESET C.

In some embodiments, for example, for the SFN scheme, if a beam failure occurs, the terminal device 130 may identify two new beams. In some embodiments, in case that CORESET A and CORESET B are associated with a same BFD RS set, the terminal device 130 may indicate to higher layers whether there is at least two periodic CSI-RS configuration indexes and/or at least two SS/Physical Broadcast Channel (PBCH) block indexes or at least one periodic CSI-RS configuration index and one SS/Physical Broadcast Channel (PBCH) block index from the new beam candidate set q1 with corresponding L1-RSRP measurements that are larger than or equal to the Q_{in,LR} threshold, and provides two periodic CSI-RS configuration indexes and/or two SS/PBCH block indexes and/or one periodic CSI-RS configuration indexes and one SS/PBCH block index from the set q1 and the corresponding L1-RSRP measurements that are larger than or equal to the Q_{in,LR} threshold, if any. Regarding the candidate RS ID, both first and second fields are set to the index of an SSB with SS-RSRP above rsrp-ThresholdBFR amongst the SSBs in candidate beam list or to the index of a CSI-RS with CSI-RSRP above rsrp-ThresholdBFR amongst the CSI-RSs in candidate beam list. Index of an SSB or CSI-RS is the index of an entry in candidate beam list corresponding to the SSB or CSI-RS. Index 0 corresponds to the first entry in the candidate beam list, index 1 corresponds to the second entry in the list and so on. The length of this field is 12 bits.

In some embodiments, the plurality of sets of RSs comprises a first set of RSs (that is, S1) and a second set of RSs (that is, S2). In this case, if a beam failure is detected over S1, the terminal device 130 may identify a third RS from a sixth set of RSs. In some embodiments, the plurality of sets of RSs comprises a third set of RSs (that is, S1 or S2 or S4). The third set of RSs may include a first RS and a second RS. In this case, if a first beam failure is detected over the first RS, the terminal device 130 may identify a third RS from a sixth set of RSs. In some embodiments, the terminal device 130 may monitor the PDCCH candidate or decode the DCI associated with the PDCCH candidate using a first set of antenna port quasi co-location (QCL) parameters as those associated with the third RS. In some embodiments, the terminal device 130 may monitor the PDCCH candidate or decode the DCI associated with the PDCCH candidate with the second TCI state for CORESET C. In some embodiments, the terminal device 130 may monitor the PDCCH candidate or decode the DCI associated with the PDCCH candidate using a first set of antenna port quasi co-location (QCL) parameters as those associated with the third RS and with the second TCI state for CORESET C. In some embodiments, the terminal device 130 may not monitor the PDCCH candidate. In some embodiments, the terminal device 130 may not decode the DCI associated with the PDCCH candidate. In some embodiments, the terminal device 130 may determine or decide not to monitor the PDCCH candidate or the terminal device 130 may drop or discard or ignore the PDCCH candidate. In some embodiments, the terminal device 130 may determine or decide not to decode the DCI associated with the PDCCH candidate or the terminal device 130 may drop or discard or ignore the DCI associated with the PDCCH candidate.

In some embodiments, the plurality of sets of RSs comprises a first set of RSs (that is, S1) and a second set of RSs (that is, S2). In this case, if a beam failure is detected over S2, the terminal device 130 may identify a fourth RS from the sixth set of RSs or from a seventh set of RSs. In some embodiments, the plurality of sets of RSs comprises a third set of RSs (that is, S1 or S2 or S4). The third set of RSs may include a first RS and a second RS. In this case, if a first beam failure is detected over the second RS, the terminal device 130 may identify a fourth RS from the sixth set of RSs or from a seventh set of RSs. In some embodiments, the terminal device 130 may monitor the PDCCH candidate or decode the DCI associated with the PDCCH candidate with the first TCI state for the CORESET. In some embodiments, the terminal device 130 may monitor the PDCCH candidate or decode the DCI associated with the PDCCH candidate using a second set of antenna port QCL parameters as those associated with the fourth RS. In some embodiments, the terminal device 130 may monitor the PDCCH candidate or decode the DCI associated with the PDCCH candidate using a second set of antenna port QCL parameters as those associated with the fourth RS and with the first TCI state for CORESET C. In some embodiments, the terminal device 130 may not monitor the PDCCH candidate. In some embodiments, the terminal device 130 may not decode the DCI associated with the PDCCH candidate. In some embodiments, the terminal device 130 may determine or decide not to monitor the PDCCH candidate or the terminal device 130 may drop or discard or ignore the PDCCH candidate. In some embodiments, the terminal device 130 may determine or decide not to decode the DCI associated with the PDCCH candidate or the terminal device 130 may drop or discard or ignore the DCI associated with the PDCCH candidate.

In some embodiments, if the third RS is identified and the fourth RS is not identified, the terminal device 130 may monitor the PDCCH candidate or decode the DCI associated with the PDCCH candidate using the first set of antenna port quasi co-location (QCL) parameters as those associated with the third RS. In some embodiments, if the third RS is not identified and the fourth RS is identified, the terminal device 130 may monitor the PDCCH candidate or decode the DCI associated with the PDCCH candidate using the second set of antenna port quasi co-location (QCL) parameters as those associated with the fourth RS. In some embodiments, if at least one of the third RS and the fourth RS is not identified, the terminal device 130 may not monitor the PDCCH candidate or decode the DCI associated with the PDCCH candidate. In some embodiments, if at least one of the third RS and the fourth RS is not identified, the terminal device 130 may determine or decide not to monitor the PDCCH candidate or the terminal device 130 may drop or discard or ignore the PDCCH candidate. In some embodiments, if at least one of the third RS and the fourth RS is not identified, the terminal device 130 may determine or decide not to decode the DCI associated with the PDCCH candidate or the terminal device 130 may drop or discard or ignore the DCI associated with the PDCCH candidate.

In some embodiments, the plurality of sets of RSs comprises a third set of RSs (that is, S1 or S2 or S4). The third set of RSs comprises first and second RSs. In this case, if a beam failure is detected over at least one of the first RS and the second RS or over the third set of RSs, the terminal device 130 may identify at least one of a fifth RS and a sixth RS from an eighth set of RSs. In some embodiments, in response to the fifth RS being identified, the terminal device 130 may monitor the PDCCH candidate or decode the DCI associated with the PDCCH candidate using a third set of antenna port QCL parameters as those associated with the fifth RS. In some embodiments, in response to the sixth RS being identified, the terminal device 130 may monitor the PDCCH candidate or decode the DCI associated with the PDCCH candidate using a fourth set of antenna port QCL parameters as those associated with the sixth RS. Alternatively, in some embodiments, if a beam failure is detected over at least one of the first RS and the second RS or over the third set of RSs, the terminal device 130 may not monitor the PDCCH candidate or may not decode the DCI associated with the PDCCH candidate. In some embodiments, if a beam failure is detected over at least one of the first RS and the second RS or over the third set of RSs, the terminal device 130 may determine or decide not to monitor the PDCCH candidate or the terminal device 130 may drop or discard or ignore the PDCCH candidate. In some embodiments, if a beam failure is detected over at least one of the first RS and the second RS or over the third set of RSs, the terminal device 130 may determine or decide not to decode the DCI associated with the PDCCH candidate or the terminal device 130 may drop or discard or ignore the DCI associated with the PDCCH candidate.

In some embodiments, if the fifth RS is identified and the sixth RS is not identified, the terminal device 130 may monitor the PDCCH candidate or decode the DCI associated with the PDCCH candidate using the third set of antenna port quasi co-location (QCL) parameters as the ones associated with the fifth RS. In some embodiments, if the fifth RS is not identified and the sixth RS is identified, the terminal device 130 may monitor the PDCCH candidate or decode the DCI associated with the PDCCH candidate using the fourth set of antenna port QCL parameters as those associated with the sixth RS. In some embodiments, if at least one of the fifth RS and the sixth RS is not identified, the terminal device 130 may not monitor the PDCCH candidate or may not decode the DCI associated with the PDCCH candidate. In some embodiments, if at least one of the fifth RS and the sixth RS is not identified, the terminal device 130 may determine or decide not to monitor the PDCCH candidate or the terminal device 130 may drop or discard or ignore the PDCCH candidate. In some embodiments, if at least one of the fifth RS and the sixth RS is not identified, the terminal device 130 may determine or decide not to decode the DCI associated with the PDCCH candidate or the terminal device 130 may drop or discard or ignore the DCI associated with the PDCCH candidate.

In some embodiments, the PDCCH candidate may be monitored starting from or after a time point. For example, the time point may be a slot or a symbol. The terminal device 130 may decode the DCI associated with the PDCCH candidate starting from or after the time point. In some embodiments, the time point may be 28 symbols from a last symbol of a first PDCCH reception in a search set provided by recoverySeaerchSpaceId for which the terminal device detects a DCI with Cyclic redundancy check (CRC) scrambled by Cell Radio Network Temporary Identifier (C-RNTI) or Modulation and coding scheme Cell Radio Network Temporary Identifier (MCS-C-RNTI). In some embodiments, the time point may be 28 symbols from a last symbol of a PDCCH reception with a DCI scheduling a PUSCH transmission with a same hybrid automatic repeat request (HARQ) process number as for the transmission of the first PUSCH and having a toggled New Data Indicator (NDI) field value.

In some embodiments, if one CORESET is configured with two active TCI states, a spatial setting for a PUCCH transmission from the terminal device 130 may be the same as a spatial setting corresponding to the first TCI state/QCL parameters for PDCCH receptions by the terminal device 130 in the CORESET with the lowest ID. In some embodiments, the terminal device 130 may transmit PUSCH according to the spatial relation, if applicable, with a reference to the RS with ‘QCL-TypeD’ corresponding to the first TI state/QCL assumption of the CORESET with the lowest ID. In some embodiments, the terminal device 130 may assume that the DM-RS ports of PDSCH of a serving cell are quasi co-located with the RS(s) with respect to the first TCI state/QCL parameter(s) used for PDCCH quasi co-location indication of the CORESET associated with a monitored search space with the lowest controlResourceSetId in the latest slot in which one or more CORESETs within the active BWP of the serving cell are monitored by the terminal device 130. Alternatively, the terminal device 130 may assume that the DM-RS ports of PDSCH of a serving cell are quasi co-located with the RS(s) with respect to the two TI states/QCL parameter(s) used for PDCCH quasi co-location indication of the CORESET associated with a monitored search space with the lowest controlResourceSetId in the latest slot in which one or more CORESETs within the active BWP of the serving cell are monitored by the terminal device 130.

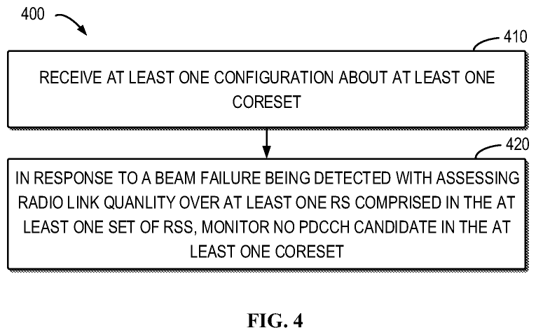

FIG. 4 illustrates a flowchart of an example method 400 for both the SFN and non-SFN schemes in accordance with some embodiments of the present disclosure. The method 400 can be implemented at the terminal device 130 as shown in FIG. 1.

As shown in FIG. 4, at block 410, the terminal device 130 receives at least one configuration about at least one control resource set (CORESET), where the at least one configuration indicates that the at least one CORESET is associated with at least one set of reference signals (RSs) for beam failure detection (BFD). At block 420, in response to a beam failure being detected with assessing radio link quality over at least one RS comprised in the at least one set of RSs, the terminal device 130 monitors no PDCCH candidate in the at least one CORESET.

In some embodiments, a terminal device may be configured with a higher layer parameter precoderGranularity equaling to allContiguousRBs, and the terminal device may be configured with a CORESET which is configured or activated with two TCI states. In some embodiments, the demodulation reference signal (DMRS) for a PDCCH is in a set of resource element groups (REGs) within the set of contiguous resource blocks in the CORESET, where the set of REGs are associated with the same TCI state as the PDCCH (or a PDCCH candidate on which the PDCCH is monitored). In some embodiments, the terminal device may assume that the same pre-coding is used across a set of REGs within the set of contiguous resource blocks, where the set of REGs are associated with same TCI state with the PDCCH (or with the PDCCH candidate on which the PDCCH is monitored).

In some embodiments, the set of REGs are contiguous within the set of contiguous resource blocks. For example, in a set of contiguous RBs, if one PDCCH (or PDCCH candidate) is monitored/detected in a first set of REGs, DMRS is assumed within a second set of subsets of REGs, where the TCI state for the first set of REGs and second set of REGs are same, and each subset of REGs in second set contains the set/subset of the first set of REGs.

In some embodiments, the terminal device shall assume the sequence rₗ(m) is mapped to resource elements (k, l)_{p,μ} according to

a_{k,l}^{(p,μ)}=β_{DMRS}^{PDCCH}·rₗ(3n+k′)

k=nN_{sc}^{RB}+4k′+1

k′=0,1,2

n=0,1, . . . (1)

where the following conditions are fulfilled
they are within the resource element groups constituting the PDCCH the terminal device attempts to decode if the higher-layer parameter precoderGranularity equals sameAsREG-bundle,
contiguous resource-element groups which are associated with same TCI state with the PDCCH within the set of contiguous resource blocks in the CORESET where the terminal device attempts to decode the PDCCH if the higher-layer parameter precoderGranularity equals allContiguousRBs.

In some embodiments, for both interleaved and non-interleaved mapping, the terminal device may assume
the same precoding being used within a REG bundle if the higher-layer parameter precoderGranularity equals sameAsREG-bundle;
the same precoding being used across the contiguous resource-element groups which are associated with same TCI state with the PDCCH within the set of contiguous resource blocks in the CORESET, and that no resource elements in the CORESET overlap with an SSB or LTE cell-specific reference signals as indicated by the higher-layer parameter lte-CRS-ToMatchAround or additionalLTE-CRS-ToMatchAroundList, if the higher-layer parameter precoderGranularity equals allContiguousRBs.

In some embodiments, the set of REGs are all the REGs associated with same TCI state within the set of contiguous resource blocks. For example, in a set of contiguous RBs, if one PDCCH (candidate) is monitored/detected in a first set of REGs, DMRS is assumed within all REGs which associated with same TCI state with the PDCCH in the set of contiguous resource blocks a second set of REGs.

In some embodiments, the terminal device shall assume the sequence rₗ(m) is mapped to resource elements (k, l)_{p,μ} according to

a_{k,l}^{(p,μ)}=β_{DMRS}^{PDCCH}·rₗ(3n+k′)

k=nN_{sc}^{RB}+4k′+1

k=0,1,2

n=0,1, . . . (2)

where the following conditions are fulfilled
they are within the resource element groups constituting the PDCCH the terminal device attempts to decode if the higher-layer parameter precoderGranularity equals sameAsREG-bundle,
all resource-element groups which are associated with same TCI state with the PDCCH within the set of contiguous resource blocks in the CORESET where the terminal device attempts to decode the PDCCH if the higher-layer parameter precoderGranularity equals allContiguousRBs.

In some embodiments, for both interleaved and non-interleaved mapping, the terminal device may assume
the same precoding being used within a REG bundle if the higher-layer parameter precoderGranularity equals sameAsREG-bundle;
the same precoding being used across the all resource-element groups which are associated with same TCI state with the PDCCH within the set of contiguous resource blocks in the CORESET, and that no resource elements in the CORESET overlap with an SSB or LTE cell-specific reference signals as indicated by the higher-layer parameter lte-CRS-ToMatchAround or additionalLTE-CRS-ToMatchAroundList, if the higher-layer parameter precoderGranularity equals allContiguousRBs.

In some embodiments, a terminal device comprises circuitry configured to: receive at least one configuration about a first control resource set (CORESET) and a second CORESET, wherein the at least one configuration indicates that the first CORESET is associated with a first set of reference signals (RSs) for beam failure detection (BFD), and the second CORESET is associated with the first set of RSs or a second set of RSs for BFD; and monitor at least one PDCCH candidate based on detection of a beam failure with assessing radio link quality over at least one of the first set of RSs and the second set of RSs.

In some embodiments, the at least one PDCCH candidate comprises at least one of: a first PDCCH candidate in a first search space associated with the first CORESET; and a second PDCCH candidate in a second search space associated with the second CORESET.

In some embodiments, the terminal device comprises circuitry configured to: decode downlink control information (DCI) associated with at least one of: the first PDCCH candidate, the second PDCCH candidate, and a combination of the first PDCCH candidate and the second PDCCH candidate.

In some embodiments, the terminal device comprises circuitry configured to: in response to a beam failure being detected over at least one of the first set of RSs and the 25 second set of RSs, disable decoding of DCI associated with at least one of: the first PDCCH candidate, the second PDCCH candidate, and a combination of the first PDCCH candidate and the second PDCCH candidate.

In some embodiments, the second CORESET is associated with the second set of RSs, and the terminal device comprises circuitry configured to: in response to a beam failure being not detected over any of the first set of RSs and the second set of RSs, monitor at least one of the first PDCCH candidate and the second PDCCH candidate; and in response to a beam failure being detected over at least one of the first set of RSs and the second set of RSs, monitor either the first PDCCH candidate or the second PDCCH candidate.

In some embodiments, the second CORESET is associated with the second set of RSs, and the terminal device comprises circuitry configured to: in response to a beam failure being detected over the second set of RSs, monitor the first PDCCH candidate without monitoring the second PDCCH candidate; and in response to a beam failure being detected over the first set of RSs, monitor the second PDCCH candidate without monitoring the first PDCCH candidate.

In some embodiments, the second CORESET is associated with the first set of RSs comprising first and second RSs, and the terminal device comprises circuitry configured to: in response to a beam failure being detected over the second RS, monitor the first PDCCH candidate without monitoring the second PDCCH candidate; and in response to a beam failure being detected over the first RS, monitor the second PDCCH candidate without monitoring the first PDCCH candidate.

In some embodiments, the second CORESET is associated with the second set of RSs, and the terminal device comprises circuitry configured to: in response to a beam failure being not detected over any of the first set of RSs and the second set of RSs, decode the DCI associated with at least one of the first PDCCH candidate, the second PDCCH candidate, and the combination of the first PDCCH candidate and the second PDCCH candidate; and in response to a beam failure being detected over at least one of the first set of RSs and the second set of RSs, decode the DCI associated with one of the first PDCCH candidate and the second PDCCH candidate.

In some embodiments, the second CORESET is associated with the second set of RSs, and the terminal device comprises circuitry configured to: in response to a beam failure being detected over the second set of RSs, decode the DCI associated with the first PDCCH candidate without decoding the DCI associated with the second PDCCH candidate; in response to a beam failure being detected over the first set of RSs, decode the DCI associated with the second PDCCH candidate without decoding the DCI associated with the first PDCCH candidate; in response to a beam failure being detected over the first set of RSs, decode the DCI associated with the combination of the first PDCCH candidate and the second PDCCH candidate by setting a weight associated with the first PDCCH candidate to be 0; and in response to a beam failure being detected over the second set of RSs, decode the DCI associated with the combination of the first PDCCH candidate and the second PDCCH candidate by setting a weight associated with the second PDCCH candidate to be 0.

In some embodiments, the second CORESET is associated with the first set of RSs comprising first and second RSs, and the terminal device comprises circuitry configured to: in response to a beam failure being detected over the second RS, decode the DCI associated with the first PDCCH candidate, without decoding the DCI associated with the second PDCCH candidate; in response to a beam failure being detected over the first RS, decode the DCI associated with the second PDCCH candidate, without decoding the DCI associated with the first PDCCH candidate; in response to a beam failure being detected over the first RS, decode the DCI associated with the combination of the first PDCCH candidate and the second PDCCH candidate by setting a weight associated with the first PDCCH candidate to be 0; and in response to a beam failure being detected over the second RS, decode the DCI associated with the combination of the first PDCCH candidate and the second PDCCH candidate by setting a weight associated with the second PDCCH candidate to be 0.

In some embodiments, the at least one configuration further indicates: the first PDCCH candidate in the first search space associated with the first CORESET is linked with the second PDCCH candidate in the second search space associated with the second CORESET.

In some embodiments, the second CORESET is associated with the second set of RSs, and the terminal device comprises circuitry configured to: receive at least one of the first set of RSs and the second set of RSs via at least one of Radio Resource Control (RRC) signaling, Medium Access Control (MAC) control element (CE) and DCI.

In some embodiments, the second CORESET is associated with the first set of RSs, and the terminal device comprises circuitry configured to: receive at least one RS comprised in the first set of RSs via at least one of RRC signaling, MAC CE and DCI.

In some embodiments, the second CORESET is associated with the second set of RSs, and the terminal device comprises circuitry configured to: determine the first set of RSs based on: a third set of RSs indicated in a first transmission configuration indicator (TCI) state for the first CORESET; or a third set of RSs indicated in the first TCI state for the first CORESET and a fourth set of RSs indicated in a second TCI state for the second CORESET; and determine the second set of RSs based on the fourth set of RSs indicated in the second TCI state for the second CORESET.

In some embodiments, the second CORESET is associated with the first set of RSs comprising a first RS and/or a second RS, and the terminal device comprises circuitry configured to: determining the first RS based on a third set of RSs indicated in a first transmission configuration indicator (TCI) state for the first CORESET; or a third set of RSs indicated in the first TCI state for the first CORESET and a fourth set of RSs indicated in a second TCI state for the second CORESET; and determine the second RS based on the fourth set of RSs indicated in the second TCI state for the second CORESET.

In some embodiments, the at least one configuration further indicates at least one of: the first CORESET is associated with a first value of an identity (ID), and the second CORESET is associated with the first value of the ID or a second value of the ID.

In some embodiments, the second CORESET is associated with the second set of RSs, and the terminal device comprises circuitry configured to: in response to a first beam failure being detected over the first set of RSs, identify a third RS from a fifth set of RSs; and in response to a second beam failure being detected over the second set of RSs, identify a fourth RS from a sixth set of RSs.

In some embodiments, the second CORESET is associated with the first set of RSs comprising first and second RSs, and the terminal device comprises circuitry configured to: in response to a first beam failure being detected over the first RS, identify a third RS from a fifth set of RSs; and in response to a second beam failure being detected over the second RS, identify a fourth RS from a sixth set of RSs.

In some embodiments, the terminal device comprises circuitry configured to: in response to the third RS being identified and the second beam failure being not detected, monitor the first PDCCH candidate by associating a first set of antenna port quasi co-location (QCL) parameters with the third RS; and monitor the second PDCCH candidate with a second TCI state for the second CORESET; and in response to the fourth RS being identified and the first beam failure being not detected, monitor the second PDCCH candidate by associating a second set of antenna port QCL parameters with the fourth RS; and monitor the first PDCCH candidate with a first TCI state for the first CORESET.

In some embodiments, the terminal device comprises circuitry configured to: in response to the first and second beam failures being detected, in response to the third RS being identified and the fourth RS being not identified, monitor the first PDCCH candidate by associating a first set of antenna port QCL parameters with the third RS, without monitoring the second PDCCH candidate; and in response to the fourth RS being identified and the third RS being not identified, monitor the second PDCCH candidate by associating a second set of antenna port QCL parameters with the fourth RS, without monitoring the first PDCCH candidate.

In some embodiments, the terminal device comprises circuitry configured to: in response to at least one of the first and second beam failures being detected and at least one of the third RS and the fourth RS being not identified, disable monitoring of the first PDCCH candidate and the second PDCCH candidate.

In some embodiments, the second CORESET is associated with the first set of RSs, and the terminal device comprises circuitry configured to: in response to a beam failure being detected over at least one of the first set of RSs, identify a fifth RS and/or a sixth RS from a seventh set of RSs; in response to the fifth RS being identified, monitor the first PDCCH candidate by associating a third set of antenna port QCL parameters with the fifth RS; and in response to the sixth RS being identified, monitor the second PDCCH candidate by associating a fourth set of antenna port QCL parameters with the sixth RS.

In some embodiments, the terminal device comprises circuitry configured to: in response to the fifth RS being identified and the sixth RS being not identified, monitor the first PDCCH candidate by associating the third set of antenna port QCL parameters with the fifth RS, without monitoring the second PDCCH candidate; in response to the fifth RS being not identified and the sixth RS being identified, monitor the second PDCCH candidate by associating the fourth set of antenna port QCL parameters with the sixth RS, without monitoring the first PDCCH candidate; and in response to at least one of the fifth RS and the sixth RS being not identified, disable monitoring of the first PDCCH candidate and the second PDCCH candidate.

In some embodiments, the terminal device comprises circuitry configured to: in response to the third RS being identified and the second beam failure being not detected, perform at least one of: decoding DCI associated with the first PDCCH candidate by associating the first set of antenna port QCL parameters with the third RS; decoding the DCI associated with the second PDCCH candidate with the second TCI state for the second CORESET; and decoding the DCI associated with the combination of the first PDCCH and the second PDCCH candidate.

In some embodiments, the terminal device comprises circuitry configured to: in response to the fourth RS being identified and the first beam failure being not detected, perform at least one of: decoding DCI associated with the first PDCCH candidate with the first TI state for the first CORESET; decoding the DCI associated with the second PDCCH candidate by associating the second set of antenna port QCL parameters with the fourth RS; and decoding the DCI associated with the combination of the first PDCCH and the second PDCCH candidate.

In some embodiments, the terminal device comprises circuitry configured to: in response to the first and second beam failures being detected, in response to the third RS being identified and the fourth RS being not identified, decode DCI associated with the first PDCCH candidate by associating the first set of antenna port QCL parameters with the third RS, without decoding at least one of the DCI associated with the second PDCCH candidate and the DCI associated with the combination of the first PDCCH candidate and the second PDCCH candidate; and in response to the third RS being not identified and the fourth RS being identified, decode the DCI associated with the second PDCCH candidate by associating the second set of antenna port QCL parameters with the third RS, without decoding at least one of the DCI associated with the first PDCCH candidate and the DCI associated with the combination of the first PDCCH candidate and the second PDCCH candidate.

In some embodiments, the terminal device comprises circuitry configured to: in response to at least one of the first and second beam failures being detected and at least one of the third RS and the fourth RS being not identified, disable decoding of at least one of: DCI associated with the first PDCCH candidate, the DCI associated with the second PDCCH candidate, and the DCI associated with the combination of the first PDCCH candidate and the second PDCCH candidate.

In some embodiments, the terminal device comprises circuitry configured to: in response to the fifth RS being identified, decode DCI associated with the first PDCCH candidate by associating the third set of antenna port QCL parameters with the fifth RS; and in response to the sixth RS being identified, decode the DCI associated with the second PDCCH candidate by associating the fourth set of antenna port QCL parameters with the sixth RS.

In some embodiments, the terminal device comprises circuitry configured to: in response to the fifth RS being identified and the sixth RS being not identified, decode the DCI associated with the first PDCCH candidate by associating the third set of antenna port QCL parameters with the fifth RS, without decoding at least one of the DCI associated with the second PDCCH candidate and the DCI associated with the combination of the first PDCCH candidate and the second PDCCH candidate; in response to the fifth RS being not identified and the sixth RS being identified, decode the DCI associated with the second PDCCH candidate by associating the fourth set of antenna port QCL parameters with the sixth RS, without decoding at least one of the DCI associated with the first PDCCH candidate and the DCI associated with the combination of the first PDCCH candidate and the second PDCCH candidate; and in response to at least one of the fifth RS and the sixth RS being not identified, disable decoding of at least one of the DCI associated with the first PDCCH candidate, the DCI associated with the second PDCCH candidate and the DCI associated with the combination of the first PDCCH candidate and the second PDCCH candidate.

In some embodiments, the at least one PDCCH candidate is monitored starting from or after a time point, and the terminal device comprises circuitry configured to: decode, starting from or after the time point, the DCI associated with at least one of the first PDCCH candidate, the second PDCCH candidate and the combination of the first PDCCH candidate and the second PDCCH candidate, wherein the time point is indicated by a slot or a symbol.

In some embodiments, a terminal device comprises circuitry configured to: receive at least one configuration about a CORESET, wherein the at least one configuration indicates that: the CORESET is associated with a plurality of sets of reference signals (RSs) for beam failure detection (BFD); the CORESET is associated with a first transmission configuration indicator (TCI) state and a second TCI state; and a PDCCH candidate in a search space associated with the CORESET is associated with a first TCI state and a second TCI state; and monitor a PDCCH candidate based on detection of a beam failure with assessing radio link quality over at least one of the plurality of sets of RSs.

In some embodiments, the terminal device comprises circuitry configured to: decode DCI associated with the PDCCH candidate.

In some embodiments, the terminal device comprises circuitry configured to: in response to a beam failure being detected over at least one of the plurality of sets of RSs, disable decoding of DCI associated with the PDCCH candidate.

In some embodiments, the first TCI state and the second TCI state are two active TCI states. For example, the first TCI state and the second TCI state may be activated for a CORESET via at least one of MAC CE and DCI.

In some embodiments, the terminal device comprises circuitry configured to: in response to a beam failure being not detected over any one of the plurality of sets of RSs, monitor the PDCCH candidate with the first TCI state and the second TCI state; and in response to the beam failure being detected over at least one of the plurality of sets of RSs, monitor the PDCCH candidate with one of the first TCI state and the second TCI state.

In some embodiments, the plurality of sets of RSs comprises a first set of RSs and a second set of RSs, and the terminal device comprises circuitry configured to: in response to a beam failure being detected over the second set of RSs, monitor the PDCCH candidate with the first TCI state; and in response to a beam failure being detected over the first set of RSs, monitor the PDCCH candidate with the second TCI state.

In some embodiments, the plurality of sets of RSs comprises a third set of RSs comprising first and second RSs, and the terminal device comprises circuitry configured to: in response to a beam failure being detected over the second RS, monitor the PDCCH candidate with the first TCI state; and in response to a beam failure being detected over the first RS, monitor the PDCCH candidate with the second TCI state.

In some embodiments, the plurality of sets of RSs comprises a first set of RSs and a second set of RSs, and the terminal device comprises circuitry configured to: in response to a beam failure being not detected over any one of the first set of RSs and the second set of RSs, decode the DCI associated with the PDCCH candidate with the first TCI state and the second TCI state; and in response to a beam failure being detected over at least one of the first set of RSs and the second set of RSs, decode the DCI associated with the PDCCH candidate with one of the first TCI state and the second TCI state.

In some embodiments, the plurality of sets of RSs comprises a first set of RSs and a second set of RSs, and the terminal device comprises circuitry configured to: in response to a beam failure being detected over the second set of RSs, decode the DCI associated with the PDCCH candidate with the first TCI state; and in response to a beam failure being detected over the first set of RSs, decode the DCI associated with the PDCCH candidate with the second TCI state.

In some embodiments, the plurality of sets of RSs comprises a third set of RSs comprising first and second RSs, and the terminal device comprises circuitry configured to: in response to a beam failure being detected over the second RS, decode the DCI associated with the PDCCH candidate with the first TCI state; and in response to a beam failure being detected over the first RS, decode the DCI associated with the PDCCH candidate with the second TCI state.

In some embodiments, the plurality of sets of RSs comprise a first set of RSs and a second set of RSs, and the terminal device comprises circuitry configured to: receive at least one of the first set of RSs and the second set of RSs via at least one of RRC signaling, MAC CE and DCI.

In some embodiments, the plurality of sets of RSs comprise a first set of RSs and a second set of RSs, and the terminal device comprises circuitry configured to: determine the first set of RSs based on a fourth set of RSs indicated in a first TCI state for the CORESET; and determine the second set of RSs based on a fifth set of RSs indicated in a second TCI state for the CORESET.

In some embodiments, the plurality of sets of RSs comprise a third set of RSs comprising first and second RSs, and the terminal device comprises circuitry configured to: determine the first RS based on a fourth set of RSs indicated in a first TCI state for the CORESET; determine the second RS based on a fifth set of RSs indicated in a second TCI state for the CORESET; and determine the third set of RSs based on a combination of the fourth set of RSs and the fifth set of RSs.

In some embodiments, the at least one configuration further indicates that the CORESET is associated with a value of an identity (ID).

In some embodiments, the plurality of sets of RSs comprise a first set of RSs and a second set of RSs, and the terminal device comprises circuitry configured to: in response to a first beam failure being detected over the first set of RSs, identify a third RS from a sixth set of RSs; and in response to a second beam failure being detected over the second set of RSs, identify a fourth RS from the sixth set of RSs or a seventh set of RSs.

In some embodiments, the plurality of sets of RSs comprise a third set of RSs comprising first and second RSs, and the terminal device comprises circuitry configured to: in response to a first beam failure being detected over the first RS, identify a third RS from a sixth set of RSs; and in response to a second beam failure being detected over the second RS, identify a fourth RS from the sixth set of RSs or a seventh set of RSs.

In some embodiments, the terminal device comprises circuitry configured to: in response to the third RS being identified and the second beam failure being not detected, monitor the PDCCH candidate or decoding the DCI associated with the PDCCH candidate by associating a first set of antenna port quasi co-location (QCL) parameters with the third RS; and/or monitor the PDCCH candidate or decoding the DCI associated with the PDCCH candidate with the second TCI state for the CORESET; and in response to the fourth RS being identified and the first beam failure being not detected, monitor the PDCCH candidate or decoding the DCI associated with the PDCCH candidate with the first TCI state for the CORESET; and/or monitor the PDCCH candidate or decoding the DCI associated with the PDCCH candidate by associating a second set of antenna port QCL parameters with the fourth RS.

In some embodiments, the terminal device comprises circuitry configured to: in response to the first and second beam failures being detected, in response to the third RS being identified and the fourth RS being not identified, monitor the PDCCH candidate or decoding the DCI associated with the PDCCH candidate by associating the first set of antenna port QCL parameters with the third RS; and in response to the fourth RS being identified and the third RS being not identified, monitor the PDCCH candidate or decoding the DCI associated with the PDCCH candidate by associating the second set of antenna port QCL parameters with the third RS.

In some embodiments, the terminal device comprises circuitry configured to: in response to at least one of the first and second beam failures being detected and at least one of the third RS and the fourth RS being not identified, disable monitoring of the PDCCH candidate; and/or disable decoding of DCI associated with the PDCCH candidate.

In some embodiments, the plurality of sets of RSs comprises a third set of RSs, and the terminal device comprises circuitry configured to: in response to a beam failure being detected over at least one of the third set of RSs, identify a fifth RS and/or a sixth RS from an eighth set of RSs; in response to the fifth RS being identified, monitor the PDCCH candidate or decoding DCI associated with the PDCCH candidate by associating a third set of antenna port QCL parameters with the fifth RS; and in response to the sixth RS being identified, monitor the PDCCH candidate or decoding the DCI associated with the PDCCH candidate by associating a fourth set of antenna port QCL parameters with the sixth RS.

In some embodiments, the terminal device comprises circuitry configured to: in response to the fifth RS being identified and the sixth RS being not identified, monitor the PDCCH candidate or decoding the DCI associated with the PDCCH candidate by associating the third set of antenna port QCL parameters with the fifth RS; in response to the fifth RS being not identified and the sixth RS being identified, monitor the PDCCH candidate or decoding the DCI associated with the PDCCH candidate by associating the fourth set of antenna port QCL parameters with the sixth RS; and in response to at least one of the fifth RS and the sixth RS being not identified, disable monitoring of the PDCCH candidate or disabling decoding of the DCI associated with the PDCCH candidate.

In some embodiments, the at least one PDCCH candidate is monitored starting from or after a time point, and the terminal device comprises circuitry configured to: decode, starting from or after the time point, the DCI associated with the PDCCH candidate, wherein the time point is indicated by a slot or a symbol.

In some embodiments, a terminal device comprises circuitry configured to: receive at least one configuration about at least one control resource set (CORESET), wherein the at least one configuration indicates that the at least one CORESET is associated with at least one set of reference signals (RSs) for beam failure detection (BFD); and in response to a beam failure being detected with assessing radio link quality over at least one RS comprised in the at least one set of RSs, monitor no PDCCH candidate in the at least one CORESET.

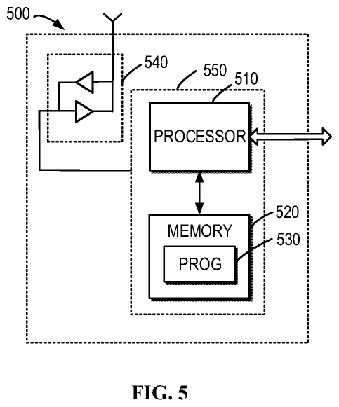

FIG. 5 is a simplified block diagram of a device 500 that is suitable for implementing embodiments of the present disclosure. The device 500 can be considered as a further example implementation of the network device 110, the terminal device 130 and/or the TRP 120 as shown in FIG. 1. Accordingly, the device 500 can be implemented at or as at least a part of the network device 110, the terminal device 130 and/or the TRP 130 as shown in FIG. 1.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2, 3 and/or 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-53. (canceled)

54. A method, performed by a terminal device, comprising:
receiving a configuration, wherein the configuration comprises first and second control resource sets (CORESETs);
assessing downlink radio link quality based on a first set of reference signals (RSs) and a second set of RSs in order to detect beam failure;
wherein, the first set of RSs and the second set of RSs are determined based on RS sets indicated by transmission configuration indicator (TCI) state for the first and second CORESETs that the terminal device uses for monitoring physical downlink control channel (PDCCH), respectively, in a case where the first set of RSs and the second set of RSs are not provided.

55. The method of claim 54, wherein,
the first and second CORESETs are associated with a first value of a CORESET pool index and a second value of the CORESET pool index, respectively.

56. The method of claim 54, the method further comprising:
determining a first set of antenna port quasi co-location parameters corresponding to a third RS from a third set of RSs, for the first CORESET, in a case where beam failure being detected over the first set of RSs.

57. The method of claim 54, the method further comprising:
determining a second set of antenna port quasi co-location parameters corresponding to a fourth RS from a fourth set of RSs, for the second CORESET, in a case where beam failure being detected over the second set of RSs.

58. The method of claim 54, the method further comprising:
receiving the first set of RSs and the second set of RSs by a Medium Access Control (MAC) control element (CE).

59. The method of claim 58, wherein the terminal device is configured with a single frequency network (SFN) scheme for PDCCH.

60. A method, performed by a terminal device, comprising:
receiving a configuration, wherein the configuration comprises two transmission configuration indicator (TCI) states for physical downlink control channel (PDCCH) reception for a control resource set (CORESET);
assessing downlink radio link quality based on a set of reference signals (RSs) in order to detect beam failure, wherein the set of RSs are determined based on RS sets associated with the two TCI states.

61. A method, performed by a network device, comprising:
transmitting a first configuration, wherein the configuration comprises first and second control resource sets (CORESETs);
determining a first set of reference signals (RSs) and a second set of RSs for assessing downlink radio quality in order to detect beam failure;
wherein, the first set of RSs and the second set of RSs are determined based on RS sets indicated by transmission configuration indicator (TCI) state for the first and second CORESETs that a terminal device uses for monitoring physical downlink control channel (PDCCH), respectively, in a case where the first set of RSs and the second set of RSs are not provided to the terminal device.

62. The method of claim 61, wherein,
the first and second CORESETs are associated with a first value of a CORESET pool index and a second value of the CORESET pool index, respectively.

63. The method of claim 61, the method further comprising:
determining a first set of antenna port quasi co-location parameters corresponding to a third RS from a third set of RSs, for the first CORESET, in a case where beam failure being detected over the first set of RSs.

64. The method of claim 61, the method further comprising:
determining a second set of antenna port quasi co-location parameters corresponding to a fourth RS from a fourth set of RSs, for the second CORESET, in a case where beam failure being detected over the second set of RSs.

65. The method of claim 61, the method further comprising:
transmitting the first set of RSs and the second set of RSs by a Medium Access Control (MAC) control element (CE).

66. A method, performed by a network device, comprising:
transmitting a configuration, wherein the configuration comprises two transmission configuration indicator (TCI) states for physical downlink control channel (PDCCH) reception for a control resource set (CORESET);
determining a set of reference signals (RSs) for assessing downlink radio link quality in order to detect beam failure, wherein the set of RSs are determined based on RS sets associated with the two TCI states.

67. The method of claim 66, wherein a single frequency network (SFN) scheme for PDCCH is configured.

68. A terminal device, comprising a processor configured to cause the terminal device to:
receive a configuration, wherein the configuration comprises first and second control resource sets (CORESETs);
assess downlink radio link quality based on a first set of reference signals (RSs) and a second set of RSs in order to detect beam failure;
wherein, the first set of RSs and the second set of RSs are determined based on RS sets indicated by transmission configuration indicator (TCI) state for the first and second CORESETs that the terminal device uses for monitoring physical downlink control channel (PDCCH), respectively, in a case where the first set of RSs and the second set of RSs are not provided.

69. The terminal device of claim 68, wherein, the first and second CORESETs are associated with a first value of a CORESET pool index and a second value of the CORESET pool index, respectively.

70. The terminal device of claim 68, the processor being further configured to cause the terminal device to:
determine a first set of antenna port quasi co-location parameters corresponding to a third RS from a third set of RSs, for the first CORESET, in a case where beam failure being detected over the first set of RSs.

71. A network device, comprising a processor configured to cause the network device to:
transmit a first configuration, wherein the configuration comprises first and second control resource sets (CORESETs);
determine a first set of reference signals (RSs) and a second set of RSs for assessing downlink radio quality in order to detect beam failure;
wherein, the first set of RSs and the second set of RSs are determined based on RS sets indicated by transmission configuration indicator (TCI) state for the first and second CORESETs that a terminal device uses for monitoring physical downlink control channel (PDCCH), respectively, in a case where the first set of RSs and the second set of RSs are not provided to the terminal device.

72. The network device of claim 71, wherein,
the first and second CORESETs are associated with a first value of a CORESET pool index and a second value of the CORESET pool index, respectively.

73. The network device of claim 71, the processor being configured to cause the network device to:
determine a first set of antenna port quasi co-location parameters corresponding to a third RS from a third set of RSs, for the first CORESET, in a case where beam failure being detected over the first set of RSs.
